(19) United States
(12) Patent Application Publication
(10) Pub. No.: US 2009/0014270 A1
(43) Pub. Date: Jan. 15, 2009

(54) Clutch unit

(75) Inventors: Mathieu Jordan, Strasbourg (FR); Karl-Ludwig Kimmig, Ottenhofen (DE); Phillipe Mih, La Wantzenau (FR)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/156,124

(22) Filed: May 29, 2008

Related U.S. Application Data
(63) Continuation of application No. PCT/DE2006/001921, filed on Oct. 2, 2006.

(30) Foreign Application Priority Data
Nov. 29, 2005 (DE) 10 2005 057 232.4
Nov. 2, 2006 (DE) PCT/DE2006/001921

(51) Int. Cl. F16D 13/04

(52) U.S. Cl. 192/70.22

(57) ABSTRACT

A clutch unit including at least one friction clutch having a pressure plate and an opposed pressure plate between which the friction linings of a clutch disk are clampable. A lever system pivotable in an axial direction is provided on an opposite side of the opposed pressure plate and can be actuated to engage the clutch. The lever system is tiltable about an annular-shaped bearing that is supported by the opposed pressure plate. The lever system is also connected radially outwardly to the opposed pressure plate via a spring. The bearing is supported on an adjusting ring of an adjusting device to compensate at least for the wear that occurs on the friction linings of the clutch plate, which is rotatable relative to the pressure plate.

### CROSS-REFERENCE TO RELATED APPLICATION

This is a continuation of International Application Serial No. PCT/DE2006/001921, with an international filing date of Nov. 2, 2006, and designating the United States, the entire contents of which is hereby incorporated by reference to the same extent as if fully rewritten.

### BACKGROUND OF THE INVENTION

1. Field of the Invention

The present invention relates to clutch units that include at least one friction clutch, with a pressure plate that is rotationally fixed but capable of limited axial movement in relation to an opposed pressure plate that is operatively connected to the output shaft of an engine. The pressure plate and the opposed pressure plate each have a friction surface, between which the friction linings of a clutch disk can be clamped. The pressure plate is provided axially on one side of the opposed pressure plate, and a lever system that can be pivoted in an axial direction is provided on the other side of the opposed pressure plate. The lever system can be contacted by an actuating device in order to engage the clutch. It can be tilted in the manner of a dual-armed lever about an annular-shaped swivel bearing that is supported by the opposed pressure plate, or by a component that is connected to it. The lever system is also connected radially outwardly to the opposed pressure plate via tension means. Additionally, the swivel bearing is supported on an adjusting ring of an adjusting device in order to compensate at least for the wear that occurs on the friction linings of the clutch plate, which can be rotated at least in relation to the pressure plate.

2. Description of the Related Art

Such clutch units have been proposed in, for example, German published patent application DE 10 2004 018 377 A1. There the previously described friction clutch is integrated into a clutch unit that is designed as a so-called double clutch.

Clutches with automatic adjustment to at least compensate for the friction lining wear are known in principle. In that connection reference is made to German published applications DE 29 16 755 A1 and to DE 35 18 781 A1, for example. In those known clutches, a practically constant force is supposed to be applied to the pressure plate by the compression spring.

An object of the present invention is to design clutch units of the type identified above in such a way that they make possible a compact design, at least in the axial direction. Another object of the present invention is to also keep the actuation path of the actuating element that acts on the lever system and that introduces the engaging force into the clutch short and essentially constant over the life of the clutch. Furthermore, a clutch unit designed according to the present invention should ensure optimized functionality and a long service life, as well as being economical to produce.

### SUMMARY OF THE INVENTION

The above-mentioned objects are achieved in part by the fact that the lever system has axial spring properties that cause it to be forced in the direction of a position having the shape of a truncated cone, which corresponds to the disengaged state of the friction clutch. Over the pivot angle necessary to engage the friction clutch the lever system exhibits a declining force-deformation spring characteristic. Additionally, spring means that act axially on the lever system are present, which include at least one diaphragm-spring-like spring element that is operationally clamped between the opposed pressure plate, or a component connected to it, and the lever system, as well as at least one other spring element that is provided between the pressure disk plate and the opposed pressure plate. The diaphragm-spring-like spring element produces an axial force on the lever system that is directed axially opposite to the actuating force necessary to pivot the lever system, and the other spring element introduces an axial force that is directed axially opposite to the force produced by the diaphragm-spring-like spring element through the tension means onto the lever system. The resulting axial force exerted on the lever system by the spring means exhibits a declining force-deformation characteristic over the engagement travel distance of the friction clutch.

The lever system can be formed in an advantageous way by a plurality of levers oriented radially in an annular-shaped arrangement. In order to give such a lever system the necessary axial spring properties, the individual levers can be coupled with each other. Connecting segments formed in a single piece with the levers can be provided for the coupling. Those connecting segments, together with the levers, can form an annular-shaped energy storage element. The connecting segments provided between the adjacent levers can also follow a loop-shaped pattern in a radial direction, however. The desired spring characteristic for the lever system can thus be realized through appropriate design of the connecting segments present between the individual levers. In addition to, or as an alternative to, the connecting segments, an annular spring, for example in the nature of a diaphragm spring, can be utilized, which is connected at least axially to the individual levers and is elastically deformed due to their swiveling.

To build the adjusting device, it can be useful if the adjusting ring is supported axially by means of a ramp system in an annular-shaped arrangement. It can be supported indirectly or directly on the opposed pressure disk plate. The ramp system advantageously has a plurality of ramps extending in a circumferential direction and rising in the axial direction. The gradient angle of the ramps is preferably designed so that there is a self-locking effect present within the ramp system. If necessary, the ramps can be provided with a certain roughness, or with slight profiling along their extent (in saw-tooth form, for example). The roughness or profiling themselves are designed so that it is possible to shift the ramps in the direction of adjustment, but to prevent them from sliding down. The adjusting function of the ramp system can be ensured in a simple manner by means of at least one energy storage element that biases the ramp system in the direction of adjustment.

In an advantageous manner, the diaphragm-spring-like spring element that acts on the lever system can be provided between the latter and the opposed pressure plate.

The additional spring elements provided between the pressure disk plate and the opposed pressure plate can be made up easily of axially biased leaf springs. Such leaf springs are firmly connected to the opposed pressure plate on at least one end and firmly connected to the pressure plate by another end or region. Such spring elements ensure on the one hand the transmission of torque between the pressure plate and the opposed pressure plate, and on the other hand they ensure the axial shifting of the pressure plate during operation of the clutch. It is especially advantageous if the spring elements are constructed with a bias in such a way that they press or force the pressure plate axially in the direction of disengagement of the clutch.

For the functioning of the clutch system or of the friction clutch, it can be especially advantageous if a lining resiliency is present between the back-to-back friction linings of the clutch plate. Such a lining resiliency causes an additional axial supporting force to be exerted on the lever system in the direction of the pivot support as soon as the friction linings are moved axially toward each other by the pressure plate, which causes the lining resiliency to come under stress. The effect of the lining resiliency is transmitted through the tension means to the lever system.

It is especially advantageous for the functioning of the adjusting device if the axial forces acting on the lever system in the direction of engagement are in equilibrium with the total spring force acting on the lever system, which acts opposite to the direction of engagement, when the pressure disk plate is at least approximately in contact with the adjacent friction lining and when there is no wear on the friction lining. The total spring force is produced at, least in part by at least one diaphragm-spring-like component clamped between the lever system and the opposed pressure plate or a tensioned diaphragm-spring-like component connected to the latter, as well as by leaf springs operationally clamped between the pressure plate and the opposed pressure plate, and possibly by an axial supporting force produced by the lining resiliency in consequence of the support of the pressure plate against the adjacent friction lining. The axial effect of the diaphragm-spring-like component on the lever system is in the opposite direction to the axial effect of the compressed leaf springs, and possibly to the axial force produced by the lining resiliency on the lever system.

Advantageously, the clutch unit can be constructed in such a way that the compensation for wear by the adjusting device takes place at least substantially during a disengagement phase of the clutch unit or of the friction clutch. The adjusting device is preferably designed and coordinated with the other components of the clutch unit or of the friction clutch in such a way that the adjustment for wear takes place at least approximately when the lining resiliency is fully relaxed, during a disengagement phase of the clutch unit or of the friction clutch.

### BRIEF DESCRIPTION OF THE DRAWINGS

Additional benefits, both in construction and in function, will be explained in greater detail in conjunction with the following description of the drawing.

The figures show the following:

FIG. 1: a half-sectional view through an embodiment of a friction clutch designed according to the present invention,

FIG. 2: a detail of the adjusting device that is used with the friction clutch shown in FIG. 1,

FIGS. 3 to 7: graphs of various characteristic curves, from which the interaction of the individual spring elements and adjusting elements of a friction clutch according to the present invention can be seen, and

FIG. 8: a half-sectional view of a dual-clutch unit having a friction clutch according to FIG. 1.

### DESCRIPTION OF THE PREFERRED EMBODIMENTS

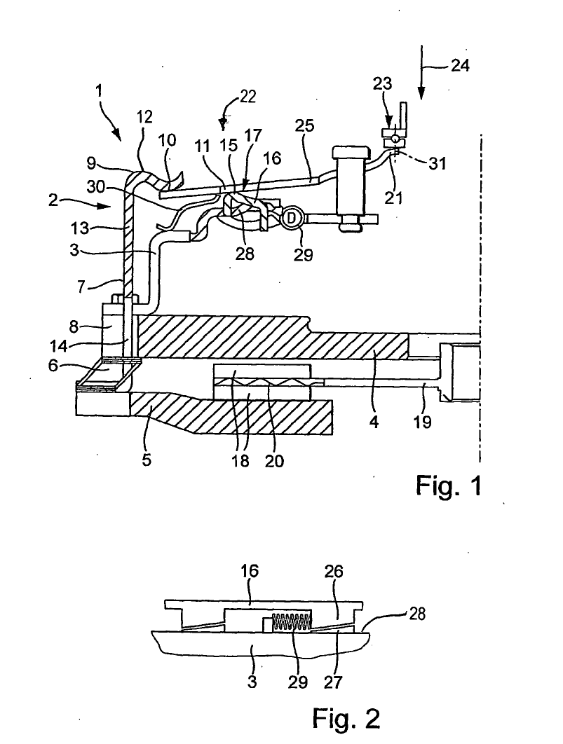

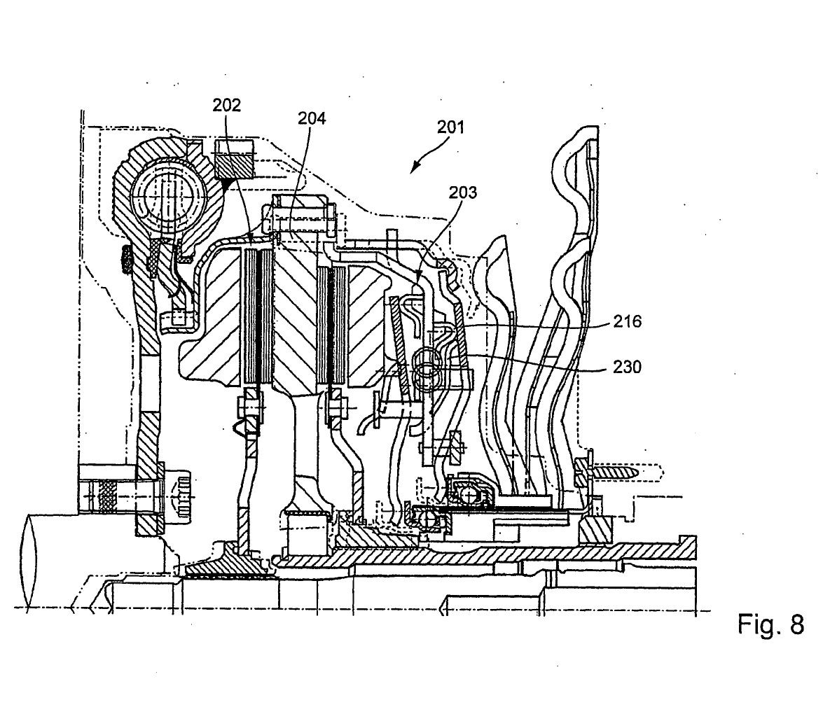

The clutch unit 1 shown in FIG. 1 in a half-sectional and schematic view is an exemplary embodiment and includes at least one friction clutch 2. The friction clutch 2 shown in the exemplary embodiment includes a housing 3, which is connected firmly or rigidly to an opposed pressure plate 4. In the illustrated exemplary embodiment, the housing 3 also time forms the housing of another friction clutch, whose additional components such as a lever system, a pressure plate, etc., are situated axially between the housing 3 and the opposed pressure plate 4, as can be seen in FIG. 8.

In addition, friction clutch 2 includes a pressure plate 5 that is situated on the side of opposed pressure plate 4 facing away from housing 3. Pressure plate 5 is non-rotatably connected to opposed pressure plate 4 but with limited axial movement by means of spring elements in the form of leaf springs 6. For that purpose the ends of the leaf springs 6 are firmly connected on one end to pressure plate 5 and on the other end to opposed pressure plate 4, for example by means of riveted connections.

Pressure plate 5 holds tension means 7, which extend axially through open spaces 8 in opposed pressure plate 4 and carry a pivot support 10 on their end 9 facing away from pressure plate 5, on which pivot support a lever element 11 is supported so that it is tiltable, or pivotable. In the illustrated exemplary embodiment the pivot support 10 is made in one piece with the tension means 7, and is formed by regions 12 of the tension means 7 that are directed radially inward.

The tension means 7 can be formed by individual hook-type components distributed around the circumference of opposed pressure plate 4. In an advantageous manner, however, tension means 7 can also be formed by a component preferably made from sheet metal, which has an annular-shaped region 13 from which a plurality of axial shanks 14 extend which are firmly connected to pressure plate 5.

Radially inward of pivot support 10, lever element 11 is carried on an annular-shaped support 15. Annular-shaped support 15 is carried or formed by an annular-shaped component 16, which is a component of an adjusting device 17, by means of which the wear that occurs on at least the friction linings 18 of a clutch plate 19 can be at least partially compensated for automatically.

The friction linings 18 are clamped between pressure plate 5 and the opposed pressure plate 4 when clutch 2 is engaged. As indicated earlier, opposed pressure plate 4 can be a component of a clutch unit that includes two clutches. Such double clutch units can be used in combination with so-called power-shift transmissions, for example.

Between the friction linings situated axially back to back there is preferably a so-called lining resiliency system 20, which ensures a progressive build-up of the torque transmittable by friction clutch 2 as the friction clutch is engaged. Such lining resiliency systems have become known through German published patent applications DE 198 57 712 A, DE 199 802 04 T1, or DE 29 515 73 A1, for example.

The lever element 11 that can be clamped axially between the pivot support 10 and the annular support 15 has changeable conical form, and it preferably has inherent springiness or elasticity that brings about a change in the conical shape of the lever element 11 that causes the friction clutch 2 to disengage. To engage friction clutch 2, force is applied to the radially inner tips 21 of the levers 22 that form lever element 11. To that end an actuating element 23 that introduces the engaging force at least substantially into friction clutch 2 is provided, and moves in the direction of arrow 24 to engage friction clutch 2. The actuating element 23 advantageously includes a roller bearing and forms a component of an actuation system that can be designed as a pneumatic, hydraulic, electrical, or mechanical actuation system, or has a combination of those actuation options, i.e., that is designed, for example, as an electrohydraulic actuation system.

The lever element 11 is formed in an advantageous manner by a large number of levers 25 provided in an annular-shaped arrangement, which are connected with each other in an advantageous manner in the circumferential direction. The connections present between the individual levers 25 can be designed in a single piece with these levers, or can be formed by an additional spring element, for example annular-shaped diaphragm springs, connected to the levers 25. The connections provided between the individual levers 25 are suitably designed in such a way that the lever element 11 has an axial elasticity that ensures the possibility of a change in the conical shape of the lever element 11. Such lever elements have been proposed in German published patent applications DE 103 40 665 A1 and DE 199 05 373 A1, and in European published applications EP 0 992 700 B1 and EP 1 452 760 A1, for example.

The spring elements 6, which ensure the transmission of torque between pressure plate 5 and opposed pressure plate 4 or housing 3, have a defined axial bias, which ensures that pressure plate 5 is pressed in the direction of disengaging friction clutch 2. That means, in the illustrated exemplary embodiment, that pressure plate 5 is pushed axially away, in the direction of arrow 24, from opposed pressure plate 4 by the biased leaf springs 6, whereby, in turn, the friction linings 18 of clutch plate 19 can be released. Furthermore, the biasing of the leaf springs 6 ensures that pivot support 10 is constantly forced axially in the direction of the radially outer region of lever element 11.

As FIG. 2 shows schematically, annular-shaped component 16 designed as an adjusting ring includes axially raised ramps 26 extending in the circumferential direction, which rest against opposing ramps 27 carried by the housing 3. The opposing ramps 27 can be formed directly in an advantageous manner by ramps formed in the region of the housing base 28. In the circumferential direction, adjusting ring 16 is acted on by springs 29, which are biased between housing 3 and adjusting ring 16.

Additional details relating to the functioning of an adjusting device 17, the design options for the ramps 26 and opposing ramp 27, and the design and arrangement of the springs 29 can be obtained from German published applications DE 42 39 291 A1, DE 42 39 289 A1, DE 43 22 677 A1, or DE 44 31 641 A1.

In addition, lever element 11 is acted upon axially in a direction opposite to the direction of arrow 24 by a spring 30, which in this case is operatively tensioned between housing 3 and lever element 11. Spring 30 thus exerts an axial force on lever element 11, which is directed opposite to the axial force exerted by the spring elements 6 on lever element 11 through tension means 7.

In the illustrated exemplary embodiment, spring 30 is formed by a diaphragm-spring-like component, which has at least one annular-shaped basic body that functions as an energy storage element. In the illustrated exemplary embodiment, radially outer regions of spring 30 contact housing 3, and radially inner regions contact lever element 11.

As can be seen from FIG. 1, when lever element 11 is pivoted, the levers 22 are pivoted in the manner of a two-armed lever around the annular-shaped support 15. That pivoting is brought about by introducing a force onto the lever tips 21 by means of actuating element 23.

The pivoting of lever element 11 in the region of annular-shaped support 15 is ensured by the fact that the resulting axial force on lever element 11, produced by the leaf springs 6 and the engaging force introduced in the region of the lever tips 21, is greater than the axial force exerted on lever element 11 by spring 30. In the above-mentioned force condition it is also necessary to take into account the axial force produced through the ramp system 26, 27 by the springs 29, which is exerted on lever element 11 through annular-shaped component 16. That axial force must be added to the axial force exerted by spring 30. However, the following description refers only to the axial force exerted by spring 30 on lever element 11; that statement is to be taken as meaning that the axial force also includes the axial force produced by the springs 29.

In the installed, operationally ready new condition of the friction clutch 2, a basic force acts on the radially inner lever tips 21 in the direction of arrow 24; that force determines the initial position of the lever element 11 in the form of a truncated cone when friction clutch 2 is new. The operationally ready initial positions of the individual clutch components are those that exist when friction clutch 2 has been operated at least once after installation, so that the individual components can assume their initial position due to the force conditions that then occur among the various spring elements.

The basic force acting on the lever tips 21 can be ensured by means of a stop provided on the transmission side for the throw-out bearing or for actuating element 23, for example. When the engine and transmission are assembled, that stop forces the actuating element 23 into an axial position that ensures the desired basic force and/or conical shape of lever element 11. In an advantageous manner, such a stop can also be axially adjustable, so that any axial tolerances that may be present can be compensated for.

The individual axial forces acting on lever element 11 are adjusted to each other in such a way that it is impossible for the adjusting device 17 to shift as long as no wear occurs, at least on the friction linings 18. The relationship between the individual spring forces and actuating forces will be described in further detail below.

It can also be seen from FIG. 1 that as soon as the friction linings 18 begin to be clamped between pressure plate 5 and opposed pressure plate 4 during an engagement phase of clutch 2, the axial force then produced by the lining resiliency system 20 also acts on lever element 11.

The above-mentioned force ratios or force measurements ensure that, as long as there is no wear, when lever element 11 is pivoted it remains in contact with annular-shaped support 15 and is pivoted around that annular-shaped support in the manner of a two-armed lever. That causes pressure plate 5 to be acted upon and shifted by tension means 7 in the direction of clutch engagement, while at the same time the spring elements 6 formed by leaf springs are stressed. During the pivoting of lever element 11, if diaphragm-spring-like spring 30 is not supported at the radial height of annular-shaped support 15 on lever element 11, a certain elastic deformation (springing) of diaphragm-spring-like spring 30 can occur. In the exemplary embodiment illustrated in FIG. 1, a certain relaxation of diaphragm-spring-like spring 30 would occur if the supporting diameter of spring 30 on lever element 11 is greater than the diameter of annular-shaped support 15.

As mentioned earlier, when there is no wear the resulting spring force acting on lever element 11 in the direction of arrow 24 is always greater during the entire engaging and disengaging travel of friction clutch 2 than the axial force exerted by diaphragm-spring-like spring 30 on lever element 11. That prevents unintended rotation and thus repositioning in the region of adjusting device 17.

The interaction of adjusting device 17 with at least diaphragm-spring-like spring 30, leaf spring elements 6, and the closing force acting in the region of the lever tips 21, forms a wear compensation device which, when wear occurs, at least on the friction linings 18, brings about at least partial compensation of that wear through axial correction by the annular-shaped support 15. The force ratios between the various spring elements acting on lever element 11, and the elastic properties of lever element 11 itself, are preferably adjusted to each other in such a way that the necessary actuating travel in the direction of arrow 24 in the region of the lever tips 21 to engage the clutch 2 remains practically constant, while the axial position of the lever tips 21 remains practically constant with friction clutch 2 engaged and disengaged. That ensures that actuating element 23 also operates over the same axial actuation distance over practically the entire life of the friction clutch. That operating principle of the wear compensating device is achieved through appropriate design and dimensioning of the spring elements acting on lever element 11 and the elastic properties of lever element 11, while attention must be paid to the lever relationships that exist between the individual annular-shaped support, spring-actuated, and actuation regions of lever element 11.

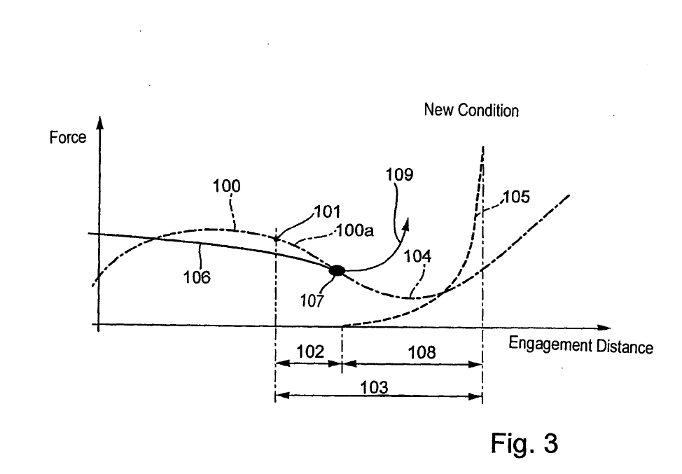

The manner of functioning of the friction clutch 2 described above will now be explained in greater detail in conjunction with the characteristics shown in the graphs in FIGS. 3 through 7.

The conditions shown in FIG. 3 correspond to the new condition of the installed friction clutch 2 after a single actuation, i.e., without any wear having occurred.

The dashed-dotted line 100 corresponds to the axial force to be exerted on the lever tips 21, which is necessary in order to bring about a change in the conical shape of the elastic lever element 11. Characteristic curve 100 refers to a deformation of lever element 11 between two annular-shaped supports whose radial spacing corresponds to the radial spacing between the annular-shaped support 15 formed by annular-shaped component 16 and the annular-shaped impingement area 31 on the lever tips 21 for actuating element 23. The operating point assumed by lever element 11 with friction clutch 2 in new condition and after the first actuation corresponds to point 101. That operating point 101 determines the angle of the installation position of lever element 11 with a new friction clutch 2 ready for operation. It can be seen from FIG. 3 that lever element 11 has a spring characteristic that exhibits a declining or diminishing force-distance path 100a, at least over the partial region 102 of the total engagement path of pressure plate 5, starting from where the friction linings 18 begin to be clamped between the friction surfaces of the pressure plate 5 and opposed pressure plate 4 as they move together. It is particularly expedient, as can be seen from FIG. 3, if that diminishing force-deformation pattern distance path extends beyond the partial region 102 in the direction of engagement. The force-path portion 104 of characteristic curve 100 over the engagement path 103 can be adjusted to the particular application through appropriate design of the resilient lever element 11.

The dashed line 105 represents the axial spreading force provided by the lining resiliency system 20, which acts between the friction linings 18. That axial spreading force works against the axial engaging force introduced through lever element 11 onto pressure plate 5. The force exerted by the lining resiliency system 20 is transmitted through tension means 7 to lever element 11. The axial force exerted by the lining resiliency system 20 operates opposite to the engaging force brought to bear on the lever tips 21, because lever 22 or lever element 11 is mounted in relation to annular-shaped support 15 in the manner of a two-armed lever, as mentioned earlier. The relationship between the force to be introduced on the annular-shaped impingement area 31 to compress the lining resiliency system 20 and the axial force exerted by the lining resiliency system 20 in the region of pivot support 10 on lever element 11 corresponds at least substantially to the relationship of the radial distance between the annular-shaped support 15 and the pivot support 10 on the one hand, and to the radial distance between the annular-shaped support 15 and the annular-shaped impingement area 31 on the other hand. With regard to the axial forces exerted axially on both sides of lever element 11, however, the axial force produced by the lining resiliency system 20 and the axial force exerted on the lever tips 21 by actuating element 23 act in the same axial direction, here in the direction of arrow 24.

The effect of the lining resiliency system is present as soon as the friction linings 18 begin to be clamped between the friction surfaces of pressure plate 5 and opposed pressure plate 4. The latter is the case after partial region 102 of the engagement path 103 has been covered by pressure plate 5 in the engagement direction. Partial region 102 corresponds to the air gap that is necessary in order to ensure a certain axial free play for the friction linings 18. Such free play is necessary in order to avoid excessive transmission of drag torque to the clutch plate 19 when friction clutch 2 is disengaged. Such drag torque would at least impair the shiftability of the transmission.

Line 106, which extends beyond control point 107 as a dashed line, represents the resulting curve of the force that is produced by the superimposition or addition of at least the force curves of the leaf springs 6 and of the diaphragm-spring-like spring 30. The forces produced at least by the leaf springs 6 and the spring 30 act in opposite axial directions on lever element 11. It can be seen in FIG. 1 that the diaphragm-spring-like spring 30 exerts a force on lever element 11 that is axially opposite in direction to the engaging force introduced in the region of the lever tips 21 and the axial force exerted on the lever element 11 by the leaf springs 6 in the region of the pivot support 10. As was mentioned earlier, the springs 29 also exert a relatively slight axial force on lever element 11 via the ramps 26, 27, which acts parallel to the force exerted by spring 30.

It can be seen from FIG. 3 that the resulting force curve according to line 106 has a characteristic pattern that declines as the tensioning or deformation of at least the spring elements 6 and 30 increases. It is evident that because of the patterns chosen for lines 100 and 106 they intersect in the vicinity of the control point 107, and that the force relationship between the two lines 100 and 106 then reverses. The result is that after the control point 107 has been passed, the resulting axial supporting force exerted on lever element 11, at least by spring elements 6 and 30, becomes greater than the engaging force exerted to deform lever element 11 in the region of the lever tips 21.

As was mentioned earlier, after partial region 102 has been traversed, i.e., when passing through control point 107, the lining resiliency 20 also become effective. As a result, when partial region 102 is traversed in the direction of engagement, the actuating force needed to pivot lever element 11 increases until the end of the engagement path 103. That increase is illustrated by the line segment 109 extending into the second partial region 108 of engagement path 103.

It is also evident from FIG. 3 that when there is no wear, i.e., when the friction clutch is in new condition, the force pattern over the partial region 102 in accordance with line 100a is greater than the force pattern that occurs over the same partial region 102 in accordance with line 106. That ensures that lever element 11 always exerts an axial force on the annular-shaped support 15, or annular-shaped component 16, which prevents twisting of that component. In the region of control point 107 there is at least an axial equilibrium present between the above-mentioned forces, as long as there is no wear, so that undesired movement within friction clutch 2 is thereby avoided. When control point 107 is passed, the additional effect of the lining resiliency 20 and the associated increase in the actuating force to engage the friction clutch serve to increase the axial force acting on annular-shaped support 15, and thus the reliability with regard to unwanted adjustment of the adjusting device 17 is also increased.

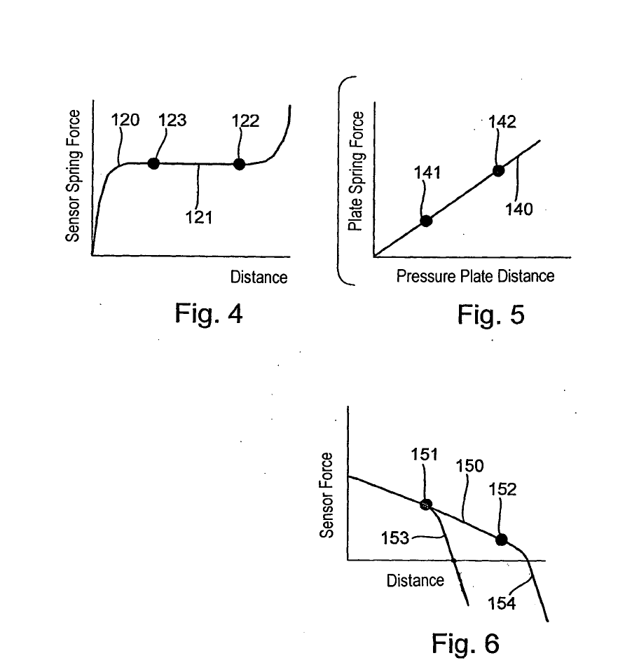

The principles of how the resulting force curve in accordance with the patterns of lines 106 and 109 in FIG. 3 comes about will now be explained briefly with reference to FIGS. 4 through 6.

FIG. 4 shows a possible spring characteristic 120 of a diaphragm-spring-like spring element corresponding to spring 30. The characteristic curve 120 for the illustrated exemplary embodiment follows a course that can be produced by appropriate coordination of the radial width and the thickness of the spring body of a diaphragm-spring-like component. The characteristic curve 120 shown has practically a plateau, or a horizontally-extending region 121. Over region 121, which runs at least substantially parallel to the abscissa, spring 30 produces an axial force that is at least substantially constant; the illustrated region 121 is practically linear. Region 121 could also have a different pattern, however, such as a slightly arched course, for example.

The biased condition of diaphragm-spring-like spring 30 with friction clutch 2 installed and ready to operate corresponds to point 122 in FIG. 4. Since over the life of friction clutch 2 the friction linings 18 are subject to wear (for example on the order of 2 to 3 mm in all), the biased condition of spring 30 changes. With maximum wear in the illustrated exemplary embodiment the spring 30 should exhibit a biased condition that corresponds to point 123, for example. Thus it is discernable from FIG. 4 that, when viewed over the life of friction clutch 2, the axial force exerted by spring 30 on lever element 11 remains at least substantially constant.

FIG. 5 shows the spring characteristic 140 that is produced in the illustrated exemplary embodiment by the leaf spring elements 6. The leaf spring elements 6 are designed so that they produce a practically linear characteristic. The leaf spring elements 6 are installed in such a way that with friction clutch 2 installed and ready for use, they exert an axial force on pressure plate 5 that corresponds to point 141. As the displacement of pressure plate 5 increases as the result of lining wear, the leaf springs 6 are biased further, so that over the life of friction clutch 2 they exert a rising axial force on pressure plate 5, and hence also on lever element 11. When maximum wear is present, the leaf spring elements 6 have an operating point that corresponds to point 142.

FIG. 6 shows the resulting force curve pattern 150, which comes about through superimposition, i.e., the addition of the linear path 121 of spring characteristic 120 of FIG. 4 and spring characteristic 140 of FIG. 5. It must be kept in mind that in reference to lever element 11, the axial forces produced by the energy storage elements 6 and 30 are axially opposed. It is evident that the resulting force pattern 150 follows a descending course over the life of friction clutch 2. The points on the characteristic curve that correspond to the new state and the worn out condition of friction clutch 2 are identified as 151 and 152, respectively.

The operating points 122, 123, 141, 142, 151, and 152 shown in FIGS. 4, 5, and 6 correspond to those operating points of the various spring elements 6 and 30 that are present for an installed, functionally ready, disengaged clutch 2.

It should also be mentioned that to produce the spring characteristic curve 140 associated with the leaf springs 6, which is shown in FIG. 5, it is expedient for the attachment regions between the leaf springs 6 and the opposed pressure plate 4—viewed in the axial direction—to be further distant from opposed pressure plate 4 than the attachment regions between the spring elements 6 and the pressure plate 5. That is not evident from FIG. 1. However, it is also possible to arrange the attachment regions of the leaf springs 6 on the components 4, 5 differently in the axial direction, in which case the progression to be produced by leaf springs 6 in the axial force which they exert can be achieved through appropriate shaping of spring elements 6, and possibly by compressing those spring elements in their longitudinal direction. If necessary, additional spring elements can also be utilized in the friction clutch 2, which interact with the other spring elements to ensure a force pattern similar to the pattern 150 shown in FIG. 6.

FIG. 6 also shows characteristic ranges 153, 154, which take account of the effect of the lining resiliency 20 that becomes effective after a defined engagement distance (for example: distance 102 shown in FIG. 3). In the graph shown in FIG. 6, the characteristic ranges 153, 154 have a downward course, because the axial force produced by the lining resiliency 20, which also acts axially on the lever element 11, is opposite in direction to the axial force exerted on lever element 11 by spring 30.

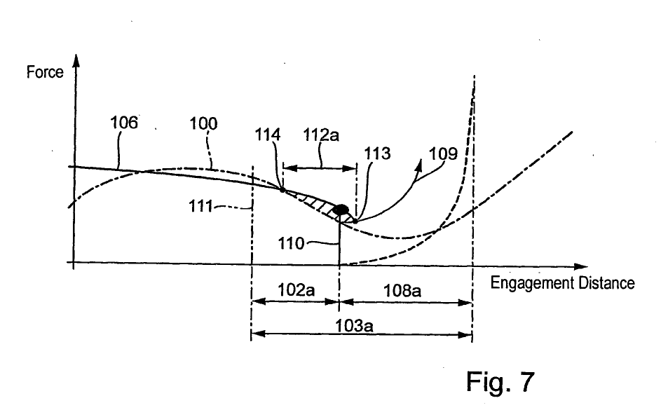

The principle that brings about an adjustment in adjusting device 17, or in the wear compensating device that includes it, will now be explained on the basis of FIG. 7. Let it first be noted that the travel ranges, or the changes in those travel ranges, referred to in order to explain the functioning of an adjusting cycle, as well as the force changes that occur, are exaggerated in order to make them easier to understand. In reality, those changes and adjustments take place in relatively small steps, and the operating or adjustment points are also subject to certain variations due to hysteresis effects and interference forces present in the friction clutch system as a whole, for example due to vibrations, so that they fall within a certain bandwidth.

The graph shown in FIG. 7 is based on the assumption that a certain amount of wear has occurred on the friction linings 18 during engagement of the friction clutch 2. That enlarges the pivot angle of lever element 11 by an amount that depends upon the extent of the wear. That is evident from the fact that the engagement path 103a of pressure plate 5 in FIG. 7 is longer than the engagement path 103 of FIG. 3; in the ideal case the difference is equivalent to at least the wear that has occurred on the friction linings 18. Assuming that the elastic properties of the lining resiliency 20 have remained the same, the partial region 108a over which the lining resiliency 20 is effective is the same length as partial region 108 of FIG. 3. Because of the wear, however, the partial region 102a between the position 110, starting from which there is no longer any effect of the lining resiliency 20 on the pressure plate 4 when disengaging clutch 2, and the position 111, which corresponds to the installation position of lever element 11 with clutch 110 disengaged, has become longer. As can be discerned in connection with FIGS. 3 and 7, the increase in the disengaging path length 102a causes the holding force that must be applied to pivot lever element 11 at the region of the lever tips 21 when disengaging the clutch 2 by a certain distance 112a, to be smaller than the resulting force (or force pattern) which is then present over that path 112a, and which forces lever element 11 away axially in the direction of annular-shaped support 15. The region resulting from the overlapping of the characteristic curves 106, 100, and 109 is shown shaded in FIG. 7.

Because of the force relationships that occur when there is wear, at least to the friction linings 8, when friction clutch 2 disengages, lever element 11 first pivots around annular-shaped support 15 in the manner of a two-armed lever. As that happens, pivot support 10 and the components connected to it are displaced axially in the direction of arrow 24, whereas the lever inner tips 21 are moved axially opposite to the direction of arrow 24. That pivoting continues until the point 113 identified in FIG. 7 has been reached. As the pivoting motion of lever element 11 in the direction of disengagement continues, lever element 11 now pivots around annular-shaped pivot support 10 in the manner of a one-armed lever. That pivoting is due to the fact that the axial actuating force introduced to lever element 11 at the region of lever inner tips 21, in the direction of arrow 24, becomes smaller as point 113 is passed than the resulting axial supporting force for lever element 11, which is opposite to the direction of arrow 24. That supporting force is supplied primarily by annular-shaped spring 30. The pivoting of lever element 11 around annular-shaped pivot support 10 continues at least approximately until point 114 is passed, when the resulting axial force acting on lever element 11 in the direction of arrow 24 again becomes greater than the resulting force pattern of line 106, which acts axially on lever element 11 opposite to the direction of arrow 24.

During the above-described operating phase, in which lever element 11 is pivoted around annular-shaped pivot support 10 in the manner of a one-armed lever, the load on adjusting ring 16 is relieved, so that the latter can follow the pivoting motion of lever element 11. That results in at least a certain adjustment for the wear occurring on the friction linings 18. The magnitude of that adjustment depends upon the lever ratios present at lever element 11. Those lever ratios are prescribed in part by the diameter of the pivot support 10, the annular-shaped support 15, and the annular-shaped impingement region 31.

The above-mentioned lever ratios, as well as the forces acting on lever element 11 that determine its pivoting and shifting, and the spring properties of lever element 11, are preferably coordinated with each other in such a way that the lever inner tips 21 remain in practically the same axial position over the life of friction clutch 2 when it is in the disengaged state. That means that although the lever inner tips 21 maintain a practically constant axial position in relation to the clutch housing 3, or in relation to the axially stationary components, the outer region of lever element 11 (at the region of annular-shaped pivot support 10) must be shifted. That is necessary in order to ensure that despite the wear occurring on the friction linings 18 and the associated axial shifting of pressure plate 5, the requisite actuating travel to engage the friction clutch 2 remains at least approximately constant at the region of the lever inner tips 21. Because of the kinematics or pivoting relationships for lever element 11 that are present in a design in accordance with FIG. 1, the axial adjusting travel that it requires at the region of annular-shaped support 15 is smaller than the amount of axial wear on the friction linings 18, and in fact corresponding to the existing lever ratios. In the exemplary embodiment shown in FIG. 1, the axial adjustment travel in the vicinity of annular-shaped support 15 is approximately 0.7 to 0.8 times the amount of axial wear, at least on the friction linings 18. Those lever ratios are determined mainly by the distance between the annular-shaped support 15 and the annular-shaped impingement region 31 on the one hand, and the radial distance between the annular-shaped pivot support 10 and the impingement region 31 on the other hand.

The target, according to which the lever inner tips 21 are supposed to maintain at least a constant axial position over the life of the friction clutch, specifies that the lever element 11 changes its tension state at least when friction clutch 2 is disengaged. That is accomplished through appropriate adjustment of annular-shaped support 15. That change also causes a change in the tension state of spring elements 6 and 30, at least when the friction clutch is disengaged. The latter is due to the fact that spring elements 6 and 30 are supported axially either indirectly or directly on lever element 11, which, in turn, assumes a tensioned position that changes over the life of the friction clutch, as mentioned earlier.

The above-mentioned changes in the tension state, at least of spring elements 6 and 30 and of lever element 11, have the result that lever element 11 and spring elements 6 are tensioned additionally by a certain amount over the life of friction clutch 2, whereas spring element 30 experiences a reduction of its tension state that exists when the friction clutch is in new condition. That means that the resulting supporting force for lever element 11 produced at least by spring elements 6 and 30 decreases with increasing wear on the friction linings 18 (as can be discerned from the various graphs in FIGS. 3 through 7). That is also represented in FIG. 3 by the dashed extension of line 106. The requisite force pattern at the region of the lever inner tips 21 to pivot the lever element 11 also decreases due to the mentioned additional tensioning of lever element 11, at least over the distance 102.

The spring characteristics of the individual elements, in particular of components 11, 6, and 30, are designed so that the previously described adjustment principle remains intact over the life of the friction clutch due to the existing force relationships, despite the above-mentioned shifts or changes in the operating point or working ranges of those spring elements.

Through appropriate design, at least of the spring elements 6 and 30, it is also possible to produce a resulting force pattern that has a substantially constant force, at least over the axial adjustment path of pressure plate 5. In FIG. 6 such a force pattern will run substantially parallel to the abscissa. In a design of that type, the resulting axial shift of lever element 11 can take place in such a way that lever element 11 always has a constant conical shape, at least when clutch 2 is in the engaged state and possibly also when it is in the disengaged state.

FIG. 8 shows a double clutch unit 201, which has two friction clutches 202 and 203 that are situated on both sides of a plate 204 designed as an opposed pressure plate. In the illustrated exemplary embodiment, friction clutch 202 is constructed with the functional arrangement of its individual components as described in connection with the preceding figures, including annular component 216 and spring 230.

1. A clutch unit comprising: at least one friction clutch having a pressure plate that is rotationally fixed and capable of limited axial movement in relation to an opposed pressure plate drivably connectable to the output shaft of an engine; wherein the pressure plate and the opposed pressure plate each have a friction surface between which friction linings of a clutch plate can be clamped; a lever system pivotable in an axial direction and positioned on an opposite side of the opposed pressure plate, wherein the lever system is acted upon by an actuating device to engage the clutch and is tiltable about an annular-shaped pivot bearing supported by the opposed pressure plate; wherein the lever system is connected radially outwardly to the opposed pressure plate via biasing means; an adjusting ring of an adjusting device supporting the pivot bearing to compensate for wear that occurs on the friction linings of the clutch plate, and which is rotatable relative to the pressure plate; wherein the lever system has axial spring properties which enable it to be forced into the shape of a truncated cone, which corresponds to the disengaged state of the friction clutch; wherein the lever system exhibits a declining force-deformation spring characteristic over a pivot angle to engage the friction clutch the lever system exhibits a declining force-deformation spring characteristic; in addition; spring means that act axially on the lever system and which include at least one diaphragm-spring-like element that is operatively clamped between the opposed pressure plate and the lever system, as well as at least one other spring element that is provided between the pressure plate and the opposed pressure plate, wherein the diaphragm-spring-like element produces an axial force on the lever system and is directed axially opposite to an actuating force for pivoting the lever system, and the other spring element introduces an axial force through the biasing means which is directed axially opposite to the force produced by the diaphragm-spring-like element through the biasing means to the lever system, while a resulting axial force exerted on the lever system by the spring means exhibits a declining force-deformation characteristic over the engagement travel distance of the friction clutch.

2. A clutch unit according to claim 1, wherein the adjusting ring is supported axially through a ramp system provided in an annular-shaped arrangement.

3. according to claim 2, wherein the ramp system extends over at least one energy storage element as an axial wear adjustment system.

4. A clutch unit according to claim 1, wherein the diaphragm-spring-like element is provided axially between the lever system and the opposed pressure plate.

5. A clutch unit according to claim 1 wherein the additional spring elements provided between the pressure plate and the opposed pressure plate are formed by axially biased leaf springs.

6. A clutch unit according to claim 1, wherein a lining resiliency is provided between the friction linings of the clutch plate.

7. A clutch unit according to claim 1, wherein when the pressure disk plate is in contact with the adjacent friction lining of the clutch plate, and when there is no wear of the friction linings, the axial forces acting in the direction of engagement on the lever system are substantially in equilibrium with the total spring force acting on the lever system opposite to the direction of engagement.

8. A clutch unit according to claim 7, wherein the total spring force is produced at least in part by at least one diaphragm-spring-like component clamped between the lever system and the opposed pressure plate, as well as by leaf springs operationally clamped between the pressure plate and the opposed pressure plate, and by an axial supporting force produced by the lining resiliency by support of the pressure plate against the adjacent friction lining.

9. A clutch unit according to claim 8, wherein the axial effect of the diaphragm-spring-like component on the lever system is in the opposite direction to the axial effect of the compressed leaf springs, and to the axial force produced by the lining resiliency on the lever system.

10. A clutch unit according to claim 1, wherein the wear compensation is accomplished by of the adjusting device during a disengagement phase of the clutch.

11. A clutch unit according to claim 1, wherein the wear compensation is accomplished by the adjusting device during a disengagement phase of the clutch, when the lining resiliency is at least approximately fully relaxed.
